(19) United States
(12) Patent Application Publication
(10) Pub. No.: US 2025/0369856 A1
(43) Pub. Date: Dec. 4, 2025

(54) METHOD AND SYSTEM FOR LABEL-FREE MICROFLUIDIC SORTING

(71) Applicant: Nanyang Technological University, Singapore (SG)

(72) Inventors: Han Wei Hou, Singapore (SG); Lingyan Gong, Singapore (SG); Chayakorn Petchakup, Singapore (SG)

(21) Appl. No.: 18/869,807

(22) PCT Filed: May 23, 2023
(86) PCT No.: PCT/SG2023/050354

§ 371 Date: Nov. 26, 2024

(30) Foreign Application Priority Data
Jun. 17, 2022 (SG) 10202250204F

(51) Int. Cl. G01N 15/1031; B01L 3/00; G01N 15/10

(52) U.S. Cl. CPC G01N 15/1031; B01L 3/502761; B01L 2200/0636; B01L 2200/0652; B01L 2300/0645; G01N 2015/1028

(57) ABSTRACT

A method of label-free sorting a plurality of particles using a system, including obtaining impedance signals of a particle as the particle is in motion toward an actuation region in a microfluidic device, determining if the particle is a target particle based on a comparison of one or more impedance-based gatings with the impedance signals of the particle, determining an actuation time for the particle, the actuation time being determined based on the impedance signals of the particle, and at the actuation time, deflecting the particle away from a default channel in the microfluidic device in response to determining that the particle is a target particle. The system comprises a microfluidic channel extending through a first detection region and a second detection region to the actuation region, the first and second detection regions having electrodes to obtain impedance signals of the particle.

### CROSS-REFERENCE TO RELATED APPLICATION

This application claims the benefit of priority to the Singapore Application No. 10202250204F filed Jun. 17, 2022, the contents of which are incorporated herein by reference in their entirety for all purposes.

### TECHNICAL FIELD

This application relates to processes and systems for handling particles in microfluidic environments.

### BACKGROUND

The ability to manipulate particles in microfluidic environments has many practical applications, e.g., in cell culturing for cell-based therapies, tissue engineering, etc. However, the handling and remote monitoring of cell cultures are conventionally manual and difficult to scale up owing to the small size and fragility of the cells or cell aggregates involved.

### SUMMARY

In one aspect, the present application discloses a method of sorting a plurality of particles. The method includes (i) obtaining impedance signals of a particle as the particle is in motion toward an actuation region in a microfluidic device, the particle being one in the plurality of particles; (ii) determining if the particle is a target particle based on a comparison of one or more impedance-based gatings with the impedance signals of the particle; (iii) determining an actuation time for the particle, the actuation time being determined based on the impedance signals of the particle; and (iv) at the actuation time, deflecting the particle away from a default channel in the microfluidic device in response to determining that the particle is a target particle.

In another aspect, the present application discloses a system configured to implement the method of sorting a plurality of particles according to the method above, the system includes: (i) a microfluidic channel extending through a first detection region and a second detection region to an actuation region, the first detection region and the second detection region having electrodes to obtain impedance signals of a particle as the particle is in motion toward the actuation region, the particle being one in the plurality of particles, the microfluidic channel dividing into a default channel and at least one sorting channel; (ii) an actuator provided at the actuation region; and (iii) a computing device configured to perform the following: determine if the particle is a target particle based on a comparison of one or more impedance-based gatings with the impedance signals of the particle; determine an actuation time for the particle, the actuation time being determined based on the impedance signals of the particle; and, in response to determining that the particle is a target particle, send instructions to actuate the actuator at the actuation time to deflect the particle away from the default channel into the sorting channel.

### BRIEF DESCRIPTION OF THE DRAWINGS

Various embodiments of the present disclosure are described below with reference to the following drawings:

FIG. 1 is a schematic diagram of a system according to one embodiment of the present disclosure;

FIG. 2A is a schematic top view of an exemplary microfluidic chip that forms part of the system of FIG. 1;

FIG. 2B is a schematic side view of the microfluidic chip of FIG. 2A;

FIG. 3A is a schematic diagram showing a method executable using the system of FIG. 1;

FIG. 3B is a schematic flowchart of a method according to one embodiment of the present disclosure;

FIGS. 4A and 4B are schematic diagrams illustrating particles in a microfluidic channel before and after hydrodynamic focusing, respectively;

FIGS. 5A, 5B, and 5C are stacked brightfield images of Cytodex microcarriers flowing through different regions of the microfluidic chip of FIG. 2A and corresponding schematic line drawing representations;

FIGS. 6A and 6B are stacked brightfield images of non-actuated particles and actuated particles respectively with corresponding schematic line drawing representations;

FIG. 7 is a schematic diagram illustrating one aspect of the present method according to embodiments of the present disclosure

FIGS. 8A and 8B are stacked brightfield images of hydrodynamically focused Cytodex microcarriers at different flow rates;

FIG. 9A is a chart plotting impedance signals against transit time of single Cytodex microcarriers;

FIGS. 9B and 9C are brightfield images of the Cytodex microcarriers used in the experiments to plot FIG. 9A;

FIG. 10A is a schematic diagram of the actuation region used in the experiments to study sorting efficiency for different excitation frequencies and different excitation wave types and FIG. 10B is a chart showing the experimental results;

FIG. 11A shows representative brightfield and fluorescent images of microcarriers with low cell density and high cell density, respectively, in experiments with cell-laden Cytodex microcarriers cultured using adipose-derived mesenchymal stem cells;

FIG. 11B are brightfield images showing microcarrier aggregates in a microchannel;

FIG. 11C are two-dimensional multi-frequency plots of cell-laden single microcarriers and aggregates;

FIG. 11D is an impedance profile of cell-laden microcarriers over periods of different number of days;

FIG. 11E is a plot showing a correlation between impedance magnitude and the number of cells cultured on the microcarriers;

FIG. 12A shows stacked brightfield images illustrating a sorting of polystyrene beads from cell-laden Cytodex microcarriers based on their impedance profiles;

FIG. 12B is a chart showing the experimental results of sorting polystyrene beads from a mixture of polystyrene beads and cell-laden Cytodex microcarriers;

FIG. 12C shows a representative fluorescent (DAPI) image of a mixture of empty and cell-laden microcarrier prior to sorting and an image of post-sorted microcarriers, experimentally verifying the effectiveness of the present method for selecting microcarriers with high cell biomass out from the mixture;

FIG. 13A is a schematic diagram of a workflow of an experiment on well-seeded microcarriers prior to cell expansion and FIGS. 13B to 13F are experimental data from the experiment of FIG. 13A;

FIG. 13B are brightfield and DAPI images of the microcarriers;

FIG. 13C is a chart of normalized impedance magnitudes before and after sorting at Day 0;

FIG. 13D is a chart of normalized impedance magnitudes before and after sorting at Day 3 and Day 6 respectively;

FIG. 13E is a plot of normalized impedance magnitude over the days;

FIG. 13F is a plot of MTT assay results over the days;

FIG. 14A is a schematic diagram of a workflow of an experiment on confluent microcarriers and FIGS. 14B to 14D are experimental data from the experiment of FIG. 14A;

FIG. 14B are DAPI images of the microcarriers before and after sorting;

FIG. 14C is a chart of normalized impedance magnitudes of samples taken from different outlets after sorting;

FIG. 14D is a chart of cell number measured via MTT assay of the samples of FIG. 14C;

FIGS. 15A-15D relate to an experiment using osteogenic undifferentiated ADSCs;

FIG. 15A is a chart showing the impedance profile of microcarriers with osteogenic differentiated and undifferentiated cells;

FIG. 15B are brightfield images showing the microcarriers before and after sorting;

FIG. 15C are DAPI images showing the microcarriers before and after sorting;

FIG. 15D is a chart showing the calcium concentration of samples after sorting;

FIGS. 16A-16F relate to an experiment with cell-encapsulated alginate microparticles;

FIG. 16A is a schematic of the electric field distributions when sensing the alginate microparticles with different biomass and cell viability;

FIG. 16B is a plot of impedance signals and the corresponding brightfield images of alginate microparticles after cell encapsulation;

FIG. 16C are DAPI and brightfield images of alginate microparticles before and after sorting;

FIG. 16D is a two-dimensional impedance scatter plot of alginate microparticles with viable (circle) and dead (cross) cells;

FIG. 16E are the impedance profiles of sorted alginate microparticles from different outlets; and

FIG. 16F are fluorescent and brightfield images of Calcein AM stained microparticles before and after sorting.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

Terms such as “first” and “second” are used in the description and claims only for the sake of brevity and clarity, and do not necessarily imply a priority or order, unless specified.

In the present disclosure, the term “particles” refers generally to the discrete matter (examples including but not limited to cells, microcarriers, cell aggregates, microbes, cell-derived vesicles, etc.) that may be found in the medium in a microfluidic system, and the term “target particles” is used to refer to the particles of interest to be sorted or separated out from a mixture of particles. Particles may include non-living or living matter. For example, a particle may be a group of multiple cells adhered, clustered, anchored or otherwise congregated together (generally referred to as a “cell aggregate”). Some cell aggregates are anchorage-dependent, with cells disposed on/in a microcarrier in a monolayer or in 3D (multiple cell layers). Microcarriers come in various configurations and may be shaped and sized according to the type and purpose of the cell culture, or according to the type of tissue being mimicked. Some microcarriers are spherical and suspended in a culture medium, such as hydrogel microcarriers, with cells growing on a surface of the microcarriers. Some cell aggregates are grown with microcarriers are porous to enable cells on a scaffold or in the pores of the scaffold. The term “particle” as used in the present disclosure may also refer to spheroids, i.e., self-organizing clusters of cells that form generally spheroid-shaped aggregates, in free suspension in a culture medium without the aid of microcarriers. Some cells positioned in an inner part of a spheroid may therefore have a slower diffusion of metabolites to the extracellular environment, compared to other cells that are positioned on the outer surface of the spheroid. Depending on the application, a particle may be a single cell. Particles may be of various different sizes, and some of them are more than 100 μm in size, or in a range of about 0.1 μm to 30 μm in size (diameter). In the present disclosure, several of the embodiments and experiments are described with respect to microcarriers and hydrogel bioparticles as these are useful particles generally challenging to sort, but it will be understood that the embodiments described herein are not limited to use with microcarriers and hydrogel bioparticles.

As used herein, the terms “dynamic” or “in motion” describes a situation in which the particles are in motion, as opposed to being “static” in which the particles are pinned or trapped and not moving. In the present disclosure, reference to the particles being “in the medium” is to be understood in general terms, without limiting the particles to a specific state or being in motion at a specific velocity. The terms “medium” and “culture medium” are also used interchangeably to refer to the blank medium, i.e., the medium alone without particles.

Sorting is a fundamental and useful function in automated processes. However, at the microfluidic level, sorting presents several technical challenges especially when the unsorted mixture is highly heterogenous. In applications where the target particles (particles to be identified and sorted out) involve living particles, sorting is complicated by the target particles in a sample having characteristics or properties that are generally non-uniform at any time instant, said characteristics or properties further changing over time with growth or proliferation. As used herein, the term “time instant” is used in a general sense of referring to a point in time or an extremely short period of time.

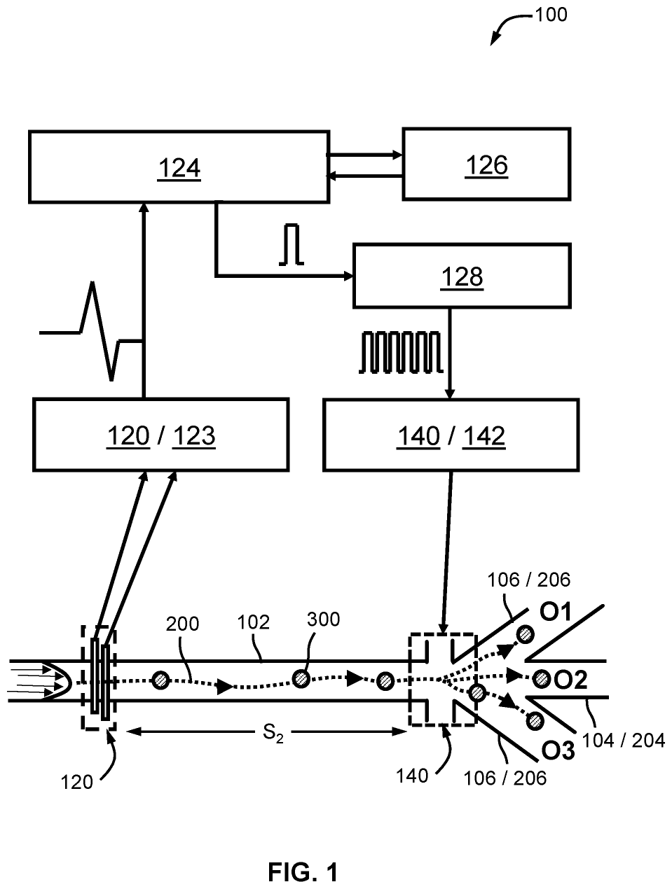

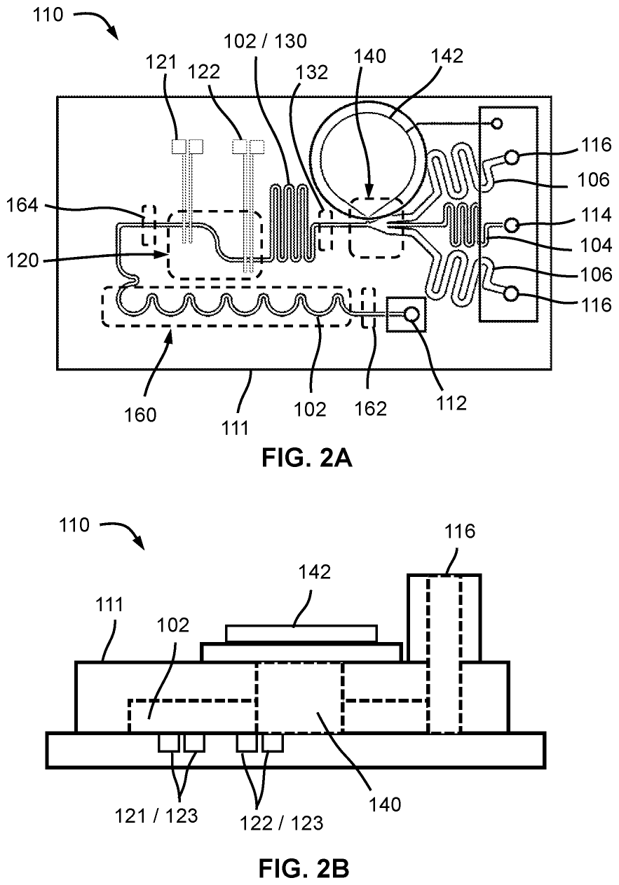

To aid understanding, FIG. 1 shows a schematic diagram of a system 100 according to one embodiment of the present disclosure. Reference is also made to FIG. 2A which shows a schematic top view of a microfluidic device 110 that may form a part of the system 100 and FIG. 2B which is one side view of the microfluidic device 110, in accordance with an embodiment of the present disclosure.

As illustrated, the system 100 includes a microfluidic channel 102 that defines a flow path 200 for a medium (with or without particles 300 therein) to flow at a flowrate (measurable with a flowmeter). The flow path 200 is configured to pass through a detection region 120 before arriving at an actuation region 140. With reference to the flow path 200, the actuation region 140 is spaced apart from and downstream of the detection region 140 by a second transit distance S₂.

The geometry of the microfluidic channel 102 may vary from one exemplary microfluidic device to another. In FIG. 1, the microfluidic channel 102 is illustrated with a straight (linear) channel geometry merely to simplify the diagram and avoid obfuscation, and not to be limiting. In the example of FIG. 2A, the microfluidic channel 102 (and accordingly the flow path 200) between the detection region 120 and the actuation region 140 is configured with a folded configuration or a serpentine geometry (also referred to as the post-detection region 130). At least a part of the microfluidic channel 102 upstream of the detection region 120 is configured as a focusing region 160. In the focusing region 160, the microfluidic channel 102 is configured in a non-linear geometry. Examples of a non-linear geometry include but are not limited to a curving geometry defined by one or more curved paths. Preferably, the non-linear geometry include a scalloped configuration or a series of open loops. In travelling along such a channel, the particles 300 experience hydrodynamic focusing such that the particles 300 become generally centrally positioned in the microfluidic channel 102. The term “focusing” may be used interchangeably with “hydrodynamic focusing”. Examples of hydrodynamic focusing includes but is not limited to inertial focusing. Hydrodynamic focusing refers generally to an alignment of the particles in which the alignment is at least partially the result of fluid flow patterns in the channel.

The detection region 120 includes a first pair of electrodes 121 (also referred to as a first detection region 121) and a second pair of electrodes 122 (also referred to as a second detection region 122), with the two pairs of electrodes 121,122 being spaced apart by a first transit distance S₁. FIG. 2B more clearly shows that the electrodes 123 are disposed in two spaced-apart pairs 121,122 with all the electrodes 123 exposed to the microfluidic channel 102. In response to an alternating excitation signal being applied to one of the electrodes 123 in each pair of electrodes 121,122, differential current changes are measurable from the other one of the electrodes in each pair of electrodes 121,122. A transimpedance/lock-in amplifier (e.g., the DHPCA-100 transimpedance amplifier, available from FEMTO) may be used to convert the sensed signals from the electrodes 123 to impedance signals and fed back to the lock-in amplifier 124 (e.g., the HF2LI lock-in amplifier, available from Zurich Instruments). The impedance signal may be continuously recorded and transferred to a processor or computing device 126 at regular intervals (e.g., in one experiment, every 400 milliseconds per interval or per burst duration). The computing device 126 is configured (e.g., using a Python program or other coding language) to process the impedance signals and obtain the following electrical signatures based exclusively on the EIS signals acquired via the electrodes 123 in the detection region 120: (i) impedance magnitude at a lower frequency (|ZLF|, e.g., at 60 kilo Hertz) and (ii) opacity. Depending on the electrical signatures obtained, the system 100 is configured to generate actuating signals using a function generator 128 to actuate an actuator 142 or to permit the actuator 142 to remain in an unactuated state. In other words, the computing device 126 is configured to send instructions to actuate the actuator if one or more impedance-based signals of a particle are found to be satisfy/not satisfy a user-defined gating upon comparison. In other words, the action, process, or mechanism by which the passage of a particle is controlled is based on one or more impedance-based signals/signature of the particle itself. That is, the decision to deflect or not to deflect (to actuate or not to actuate) may be user-defined to depend on one impedance-based parameter or to concurrently depend on more than one impedance-based parameters. In other words, particles can be sorted based on a complex combination of characteristics because the present system 100 enables sorting based on multiple electrical signatures concurrently. The gating may be expressed in terms of any one or any combination of any number of the following: an impedance-based value, an impedance-based threshold, and an impedance-based range. In the present document, the term “gatings” includes but is not limited to a simple threshold or to a single-value threshold. As will be evident from the examples described below, “gatings” may be single-parameter or multi-parameter. In one example, the flow path 200 followed by a particle 300 may be permitted to continue in a default path (non-actuated path) 204. For example, the flow path 200 followed by a particle 300 may be deflected or displaced to a deflected path (actuated path) 206. The terms “deflect” as used herein includes displacing the particle laterally relative to the flow path. The actuator 142 is preferably a piezoelectric actuator.

The opacity is defined as a ratio of impedance magnitudes, and more specifically, the ratio of the impedance magnitude at a higher frequency (|ZHF|, e.g., at 2 MHz) to the impedance magnitude at the lower frequency (|ZLF|, e.g., at 60 kHz). For the sake of brevity, as used in the present disclosure, the terms “impedance signals”, “electrical signals”, “EIS-based”, “EIS signal”, etc., refer to values, parameters, measurements, signals, ranges, trends, etc., that are determined based exclusively on readings or signals obtainable from electrochemical impedance spectroscopy without the need for supplementary data from non-EIS physical and/or chemical testing. In the present disclosure, the readings or values taken may be referred to as impedance-related signals or impedance signals. For the sake of brevity, in the present disclosure, the terms “impedance”, “impedance magnitude”, and “magnitude of the impedance” may be used interchangeably.

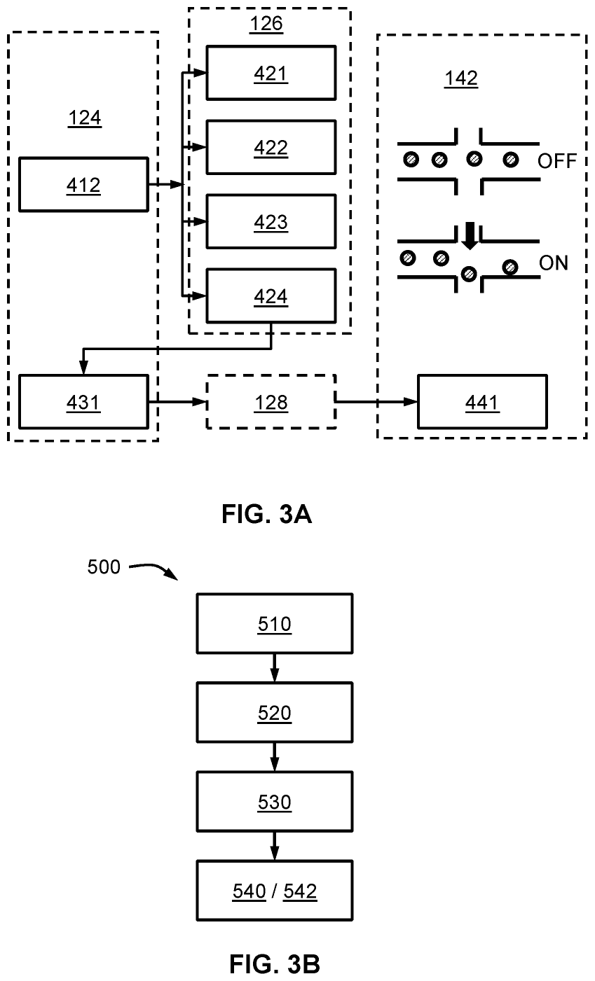

According to one embodiment of the method, the processes executable by the different devices of the system 100 under the control of a program (executable by the computing device 126 based on computer-readable instructions) may be further represented schematically as shown in FIG. 3A. The lock-in amplifier 124 may be configured to perform a method including acquiring signals (via step 412) from the electrodes 123. The computing device 126 may be configured to perform the method including acquiring data (via step 421), plotting the signals (via step 422), processing the signals (via step 423), and generating the actuation signals (via step 424), based on the signals acquired from the electrodes 123 via the lock-in amplifier 412. The lock-in amplifier 124 may be configured to receive the actuation signals generated by the computing device 126 and output as the actuation signals (via step 431) to the function generator 128. The actuation signals are used to control the actuator 142 in actuation 441.

In another aspect, as schematically represented by the flow chart of FIG. 3B, the method 500 according to embodiments of the present disclosure may be described in relation to the particles 300 under observation. The particles 300 may be described as being in a continuous flow mode when the particles 300 are being carried by, suspended in, or generally being in the medium which is pumped to move along the flow path 200. The method 500 may include focusing the particles 300 (510), detecting the particles 300 (520), determining respective particle speeds of individual particles (530), and, after a time period that is determined on a particle-by-particle basis, actuating the actuator 142 (540) or, as the case may be, not actuating the actuator 142 (542).

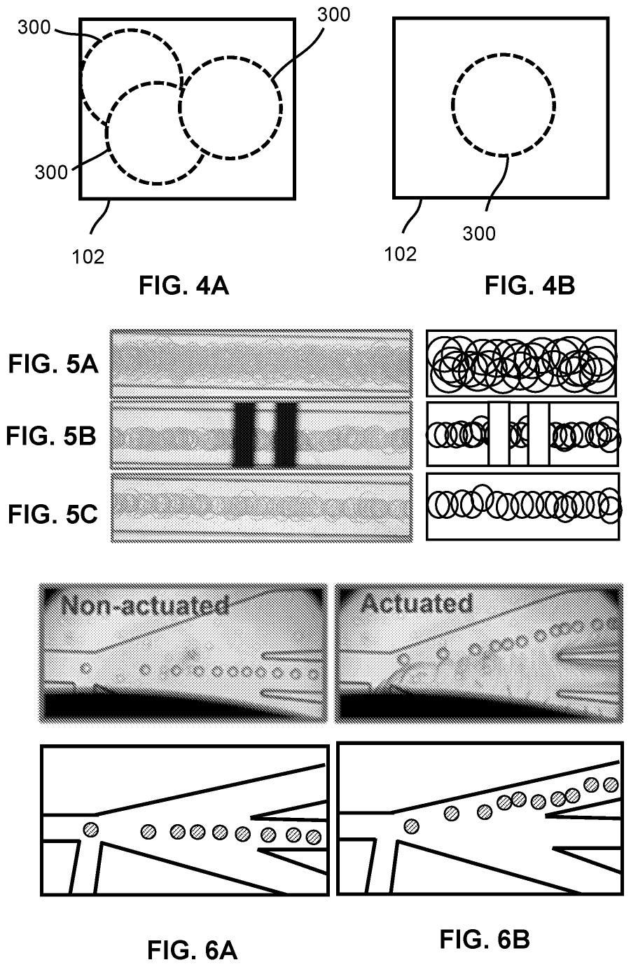

Experimental results demonstrated the utility and benefits of the proposed method and system. Some of the experiments were conducted using Cytodex microcarriers as non-limiting and exemplary particles 300. Commercially available Cytodex-3 microcarriers (diameter=175±50 μm) were loaded into the microfluidic device 110 via the inlet 112. FIG. 4A is a schematic cross-section taken near an inlet 112 to the microfluidic device 110 and at a location 162 (see FIG. 2A) upstream of the focusing region 160. FIG. 4A schematically illustrates a cross-sectional view with multiple particles randomly distributed in the microfluidic channel 102 prior to focusing. FIG. 4B shows a stream of spaced apart single or individual ones of a plurality of the particles, post focusing (e.g., at location 164 or post detection region 130), with the particle being spaced apart from the interior wall/walls of the microfluidic channel 102 and generally well-aligned in a central region of the microfluidic channel 102. The microfluidic channel 102 in the focusing region 160 may be configured in various geometries, and preferably configured to provide a flow path along a series of partial or open loops, or along a scalloped path, to provide a focusing effect on the particles 300.

FIG. 5A shows stacked brightfield images of Cytodex microcarriers at the location 162 with a corresponding simplified schematic line representation of the same. FIG. 4B is a schematic cross-section taken at a location 164 downstream of the focusing region 160 and upstream of the detection region 120. FIG. 5B shows stacked brightfield images of the Cytodex microcarriers at the detection region 120 further downstream of the focusing region 160, with a corresponding simplified schematic line representation of the same. FIG. 5C shows stacked brightfield images of the Cytodex microcarriers at the location 132 downstream of the post-detection region 130 and upstream of the actuation region 140, with a corresponding simplified schematic line representation of the same. FIG. 6A are stacked brightfield images of the Cytodex microcarriers in the actuation region 140 when the actuator 142 is in a non-actuated state, with a corresponding schematic line drawing representation. FIG. 6B are stacked brightfield images of the Cytodex microcarriers in the actuation region 140 when the actuator 142 is in an actuated state, with a corresponding schematic line drawing representation.

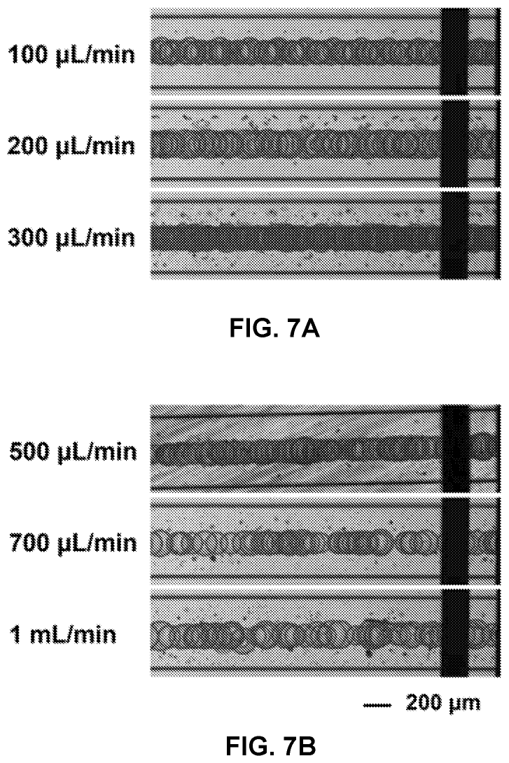

The experiments demonstrated that it is possible to maintain a fairly well aligned stream of the Cytodex microcarriers after the microcarriers travelled through the serpentine post-detection region 130. Experiments were also conducted at different flow rates in a range from 100 μL/min to 1 mL/min. As shown in the stacked brightfield images of FIGS. 7A and 7B taken at the second detection region (at the downstream pair 122 of electrodes), the Cytodex microcarriers were aligned and able to maintain the alignment produced by hydrodynamic focusing.

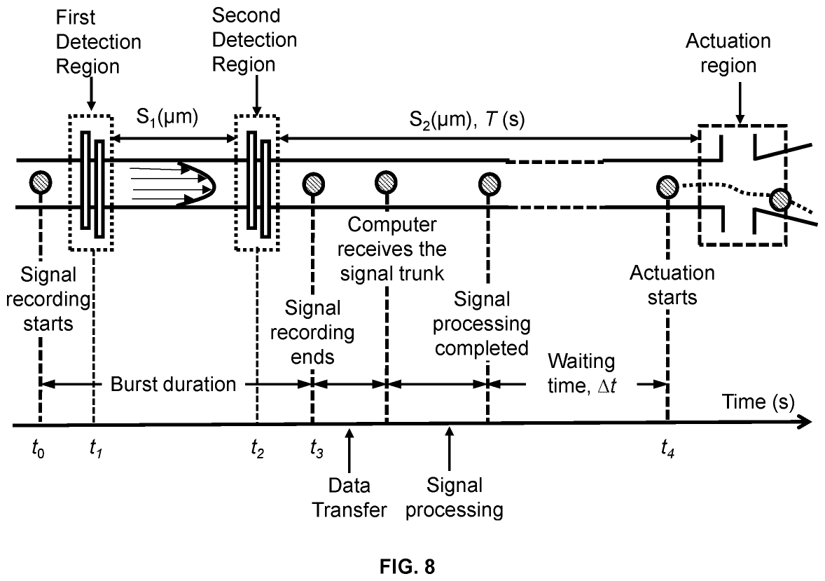

FIG. 8 is a diagram to illustrate the configuration and algorithm for impedance measurements for real-time sorting as implemented in the experiments conducted. In these experiments, the impedance signals were continuously acquired (from the electrodes 123) and recorded from a signal recording start time t₀. At a signal recording end t₃, the recorded impedance signals were sent to the computing device 126. In other words, the electrical signals were acquired continuously for a duration of time (referred to herein as the “burst duration”) and received by the computing device in the form of a signal trunk. The length of burst duration may be predetermined by the user. In the experiments conducted, a burst duration of about 400 milliseconds (ms) was sufficient for the system to capture the data needed.

Concurrent with the burst duration, electrical signals acquired from the first pair 121 of the electrodes (also referred to as the first detection region) and from the second pair 122 of the electrodes (also referred to as the second detection region) were used to determine a particle speed. The time t₁ indicated the time instant when an electrical signal was received from the first detection region/first pair of electrodes 121 and the t₂ indicated the earliest subsequent time instant after t₁ when an electrical signal was received from the second detection region/second pair of electrodes 122, the respective time instants t₁ and t₂ occurring during one or more burst durations. That is, in some examples, t₁ and t₂ may occur in different burst durations, and in some other examples, t₁ and t₂ may occur in the same burst duration. The computing device 126 was programmed to determine a particle speed v for a single particle based on the distance along the flow path from the first detection region 121 to the second detection region 122:

$$ν = {S}_{1} / ( {t}_{2} - {t}_{1} ) ,$$

where S₁ is the distance between the first detection region and the second detection region,
t₁ corresponds to a time (from t₀) for a particle to reach the first detection region, and
t₂ corresponds to a time (from t₀) for a particle to reach the second detection region.

The particle speed was determined with disregard for any flowmeter readings that may be available. The particle speed was determined based on the electrical signals received from the first detection region 121 and the second detection region 122, which corresponded well to the presence of one particle at the first detection region 121 and at the second detection region 122.

The present method 500 involves determining the transit time (t₂−t₁) for one particle (i.e., on a particle-by-particle basis) to travel from the first pair of electrodes 121 (first detection region) to the second pair of electrodes 122 (second detection region). A waiting duration A t may be determined as follows:

$$Δ t = T - ( {t}_{3} - {t}_{2} ) - {t}_{d} - {t}_{s} + {t}_{c} ,$$

where T=S₁/V
t₃ corresponds to a time when the signal recording ends,
t₂ corresponds to a time for a particle to reach the second detection region,
t_{d} is a data transfer time or time for the signal trunk to be transferred,
tₛ is a signal processing time, and
t_{c} is a time constant to compensate for minor discrepancies or minor variations.

The time constant t_{c} was found to sufficiently compensate for discrepancies or variations in the actual data transfer time and the estimated data transfer time between different equipment.

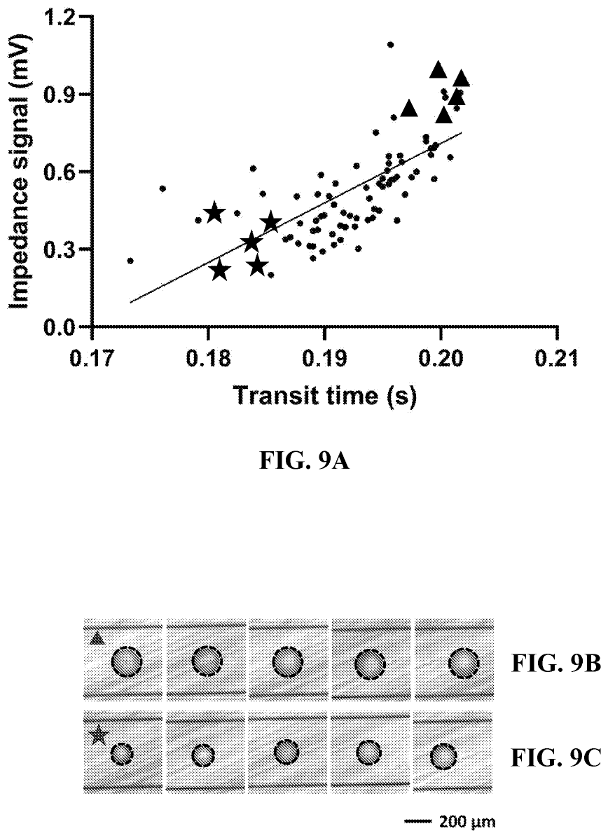

The chart of FIG. 9A shows a plot of the impedance signals of single Cytodex microcarriers and their respective transit time between the first detection region and the second detection region. FIG. 9B are representative brightfield images of microcarriers which are indicated in the plot of FIG. 9A by triangular symbols. FIG. 9C are representative brightfield images of microcarriers which are indicated in the plot of FIG. 9A by star-shaped symbols. The transit time measured could differ by about 0.02 seconds between the microcarriers of FIG. 9B and those of FIG. 9C.

FIG. 9A shows that the impedance signal (which may be taken to be indicative of microcarrier size) of single Cytodex-3 microcarriers is positively corelated to their respective transit time between the first detection region and the second detection region. The experimental data showed that the microcarriers can be highly heterogenous in size (ranging from about 125 to about 225 μm) and that this can have a significant effect on the transit time and sorting efficiency. The experimental data therefore confirms the viability of the present approach of determining the time instant for actuation for each single microcarrier separately (particle-by-particle basis) taking into consideration the respective transit time of the single microcarrier, rather relying solely on one fixed value for the entire microcarrier population (e.g., an average value of the microcarrier population).

Experiments using sine waves at 75 Hz or 100 Hz showed good performance in terms of the effectiveness and efficiency in sorting particles. As an example, to aid understanding and not to be limiting, Table 1 below presents a set of parameters that have been experimentally verified to deliver a good sorting performance:

TABLE 1
Parameters for Sorting.

| Parameters | Values | |
|---|---|---|
| Signal type | square wave | |
| Frequency | 100 | Hz |
| Cycle number | 30 | |
| Vpp | 10 | V |
| Voltage offset | 5 | V |
| Flow rate | 500 | μL/min |
| Time constant (t_{c}) | 400 | ms |
| Burst duration | 400 | ms |

As demonstrated by the experiments, the present method 500 could effectively determine the respective particle speed associated with individual particles. The respective particle speed of one particle may be determined based on electrical signals of the corresponding individual particle. In various embodiments of the method 500, the respective particle speed may be determined with disregard for the flow rate of the medium and/or the speed of any other particle. The term “flow rate” as used herein refers to the flow rate of the medium in the microfluidic device. The actuation time t₄ for one particle is based at least in part on the transit time associated with the time taken by one particle to travel between a predetermined distance, that is, on a particle-by-particle basis. The computing device 126 may be programmed to determine a sorting decision and the corresponding actuation time corresponding to the sorting decision, on a particle-by-particle basis. In other words, the actuation time and the corresponding sorting decision can be determined at a particle level. The actuation time is preferably timed to synchronize an actuation of the actuator 142 with the particle arriving at the actuation region 140. In the present method 500, the sorting process can achieve particle-level granularity.

For example, if a microcarrier 306 (as an example of a particle 300) of a specific electrical property or electrical signature is detected, an actuating signal can be generated to actuate the piezoelectric actuator 142 at a time when the microcarrier 306 is flowing through the actuation region. During the entire signal processing and data transfer time periods, the microcarrier 306 can be found flowing towards the actuation region after departing from the second detection region 122. The actuation of the actuator 142 is preferably timed to include a buffer or a waiting duration A t to improve synchronization of the actuation of the actuator with the arrival of the microcarrier 306 at the actuation region 140.

The specific geometry of the microfluidic channel(s) at the actuation region 140 and the following outlet region may vary from device to device and from application to application. In a bifurcated outlet configuration (an example of which is illustrated in FIG. 2A), if the actuator 142 is not actuated when a particle 300 travels through the actuation region 140, the particle 300 will continue to flow into the default or non-actuated channel 104 and eventually to the non-actuated outlet 114. If the actuator 142 is actuated when a particle 300 travels through the actuation region 140, the particle 300 will be displaced into a sorting channel 106 and eventually to the actuated outlet 116. There may be more than one sorting channel 106 and corresponding actuated outlet 116, as illustrated. In this example, a centrally positioned microfluidic channel is used as the default channel. The respective outputs from the actuated outlet 116 and the non-actuated outlet 114 will be the sorted results.

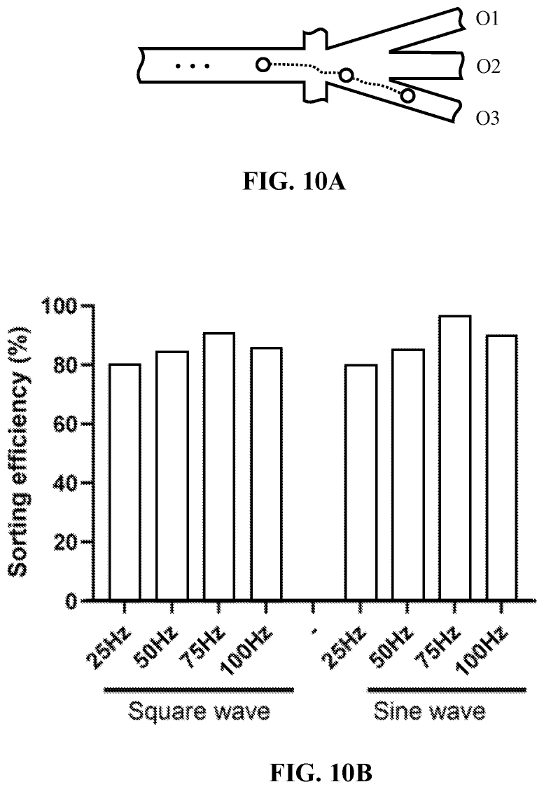

In one experiment, sine-wave signals and square-wave signals were continuously applied to the actuator 142 for continuous actuation of the microcarriers, and the corresponding sorting efficiencies were evaluated. Based on the microchannel configuration shown in FIG. 10A where O2 refers to the non-actuated channel and O1 and O3 refer to two sorting channels on either side of the non-actuated channel. The sorting efficiency was calculated as follows:

$$Sorting efficiency ( \% ) = \frac{O 1 + O 3}{O 1 + O 2 + O 3} \times 100 \%$$

The results are shown in FIG. 10B. The results show that there is no significant difference in the sorting performance between the square-wave actuating signals and the sine-wave actuating signals. Preferably, the actuating signals are configured at 75 Hz or 100 Hz, or in a range from about 75 Hz to 100 Hz.

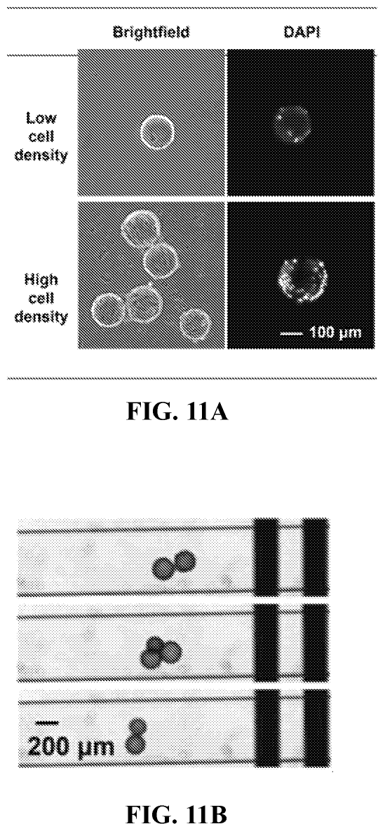

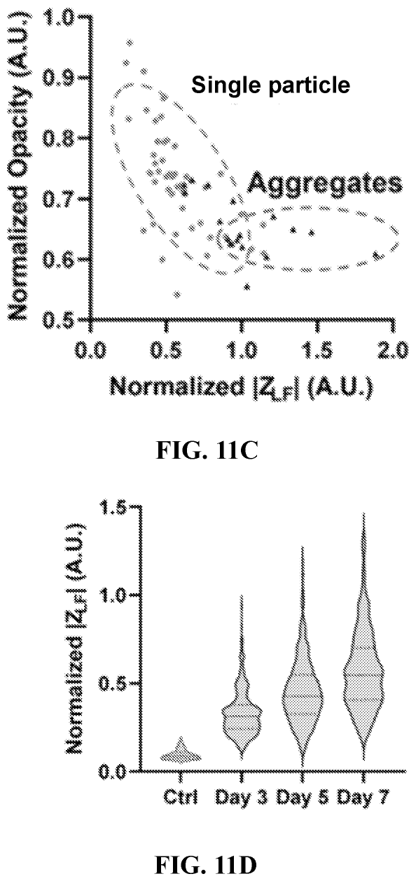

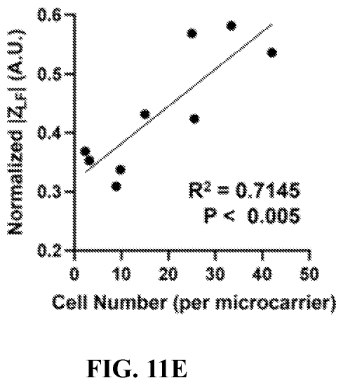

Experiments were carried out to characterize the capability of the proposed system and method in monitoring the proliferation of adipose-derived mesenchymal stem cells (ADSCs) on Cytodex-3 microcarriers. Microcarrier-based cell cultures are bulk cultures that usually result in large heterogenous of cell growth among the microcarriers. FIG. 11A shows the brightfield images and the corresponding fluorescent (DAPI) images of the Hoechst stained microcarriers with different cell densities. At low cell densities, the microcarriers had smooth surfaces and remained as single particles. At high cell densities, microcarrier surfaces were mostly covered by the cells, and tend to form aggregates due to the interactions between cells on different microcarriers (as shown in the brightfield images of microcarriers in a microfluidic channel in FIG. 11B).

The multi-frequency impedance profile of cell-laden single microcarriers and aggregates in FIG. 11C shows that as cells proliferated on single microcarriers, the impedance magnitude at low frequency (|ZLF|) increased due to the higher biomass, while the opacity decreased because the dielectric dispersion of the cell membrane resulted in a higher increase in |ZLF| than |ZHF|. The microcarriers aggregates formed at high cell densities exhibited significantly higher impedance magnitudes while the opacity remained at a similar level to single microcarriers. This indicates the capability of the proposed system and method to distinguish between single microcarriers and microcarrier aggregates.

The impedance profile (cell-laden microcarriers over number of days) in FIG. 11D shows an increasing trend in |ZLF| over time due to the higher biomass during the culture. FIG. 11E shows that the averaged cell number on each microcarrier (cells counted after trypsinization step) was strongly associated to the averaged |ZLF|. A correlation could be found between the impedance magnitude and the number of cultured cells on microcarriers. This verifies the viability of quantifying the cell density based on the respective impedance magnitude for each microcarrier. Taken together, the proposed system and method demonstrated the ability to monitor cell proliferation on microcarriers at single-particle resolution based on an impedance signature of the respective microcarrier.

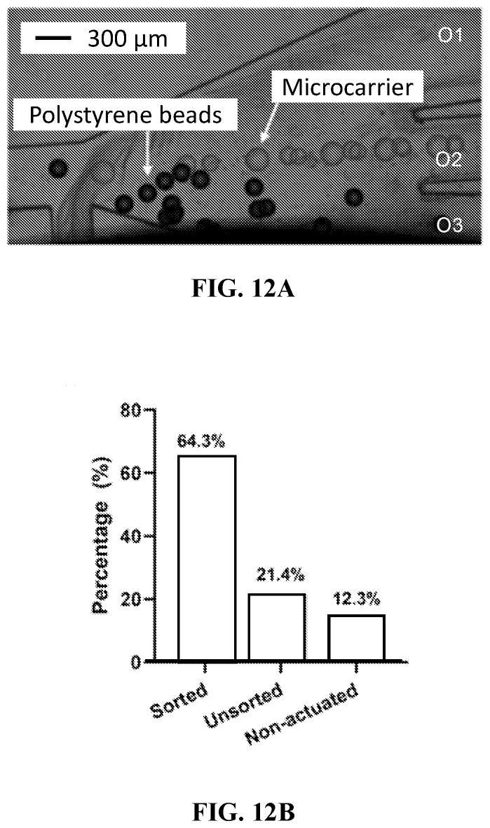

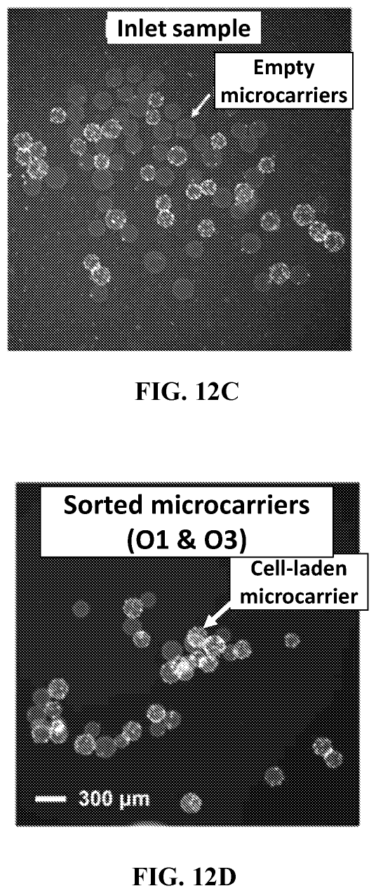

The efficiency of the present system and method of program-controlled real-time sorting was characterized in experiments using a mixture of 150 μm polystyrene beads and microcarriers. FIGS. 12A to 12E are images and data from these experiments.

FIG. 12A are stacked brightfield images of the actuation region illustrating the sorting of polystyrene beads from microcarriers based on their impedance profiles. The sorting was conducted based on the low-frequency impedance of the particles. In an ideal scenario, the polystyrene beads contributing to higher |ZLF| will be actuated and will flow into the sorting channels (sorting channels O1 and O3 leading to Outlet 1 and Outlet 3), while the microcarriers that generate lower |ZLF| will not be actuated and will flow into the non-actuated channel (default channel O2 leading to Outlet 2) along the respective trajectories (FIG. 12A).

The experimental results (FIG. 12B) showed that around 64.3% of the polystyrene beads were actuated and successfully sorted to Outlet 1 and Outlet 3. Around 21.4% of the polystyrene beads flowed to the Outlet 2 (via the non-actuated channel), i.e., the percentage of polystyrene beads that remain unsorted in the mixture is relatively small.

Similar experiments on sorting were performed using cell-laden microcarriers in the form of ADSCs. Samples of a mixture of empty microcarriers and cell-laden microcarriers were loaded into the inlet 112, and the output was collected from the sorting channels 106 (O1 and O3) via the sorting outlets 116. In these experiments, cell-laden microcarriers with higher biomass were considered as target events. This assesses the efficiency of the present system and method for selecting cell-laden microcarriers with relatively high biomass (e.g., for harvesting, etc.), while returning as many empty microcarriers back to the culture as possible (e.g., to avoid wastage from harvesting too early). The experiments sought to sort the cell-laden microcarriers into either of the sorting channels (i.e., sorting channels O1 and O3), using the impedance magnitudes to determine whether a microcarrier is empty or cell-laden. The system was configured such that selected cell-laden microcarriers will be sorted into the sorting channel(s) 106/sorting outlet(s) 116, and to permit the empty microcarriers or microcarriers with lower biomass to continue on to the default channel 104/default outlet 114.

FIG. 12C are representative fluorescent (DAPI) images of the original microcarrier sample stained with Hoechst (inlet sample taken near the inlet 112) showing a mixture of empty microcarriers and cell-laden microcarriers. FIG. 12D are representative fluorescent (DAPI) images of the (sorted) samples collected from the sorting outlets 116 (O1 and O3). It is clearly demonstrated that empty microcarriers accounted for around 50% of the inlet sample initially (FIG. 12C), and the percentage of empty microcarriers was significantly reduced in the sorted samples collected from the sorting outlets O1/O3 (FIG. 12D). In other words, it can work as a tool for real-time or dynamic sorting microcarriers with high cell biomass (high impedance) from the empty microcarriers (no cells, low impedance). Taken together, our results demonstrated the real-time actuated sorting capability of the present system and method to sort the microcarriers with different cell densities based on impedance signals.

### Well-Seeded Microcarriers

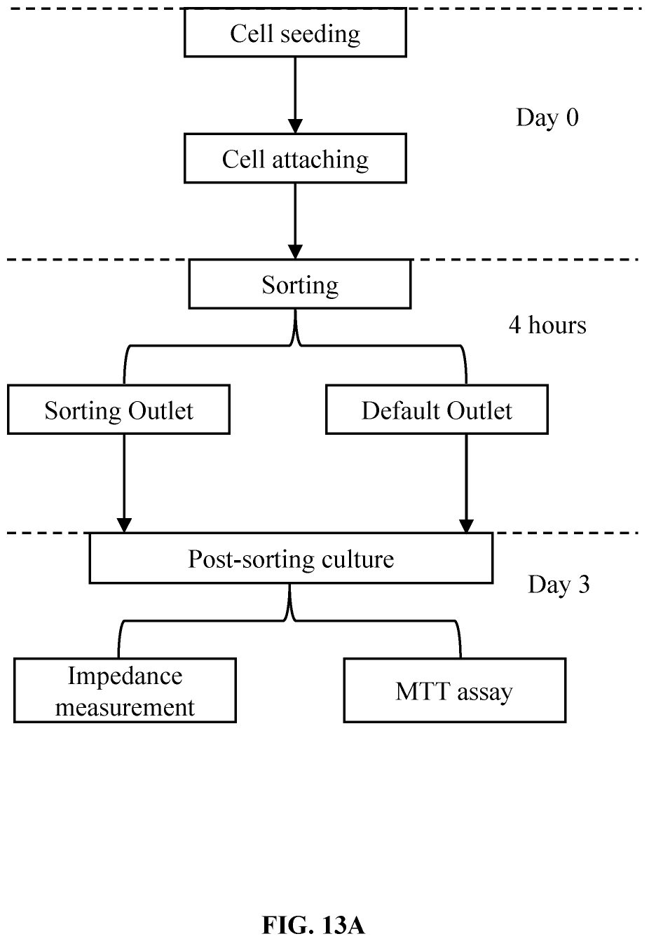

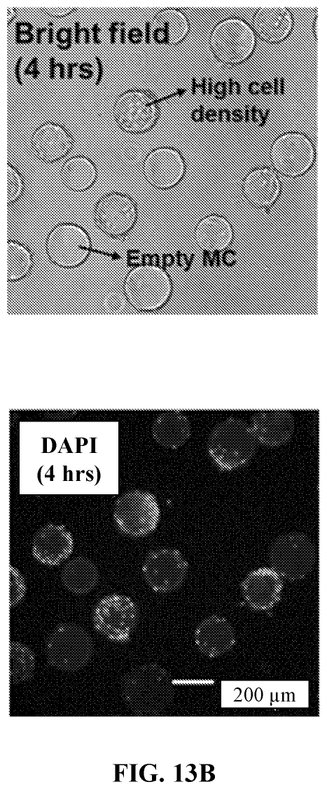

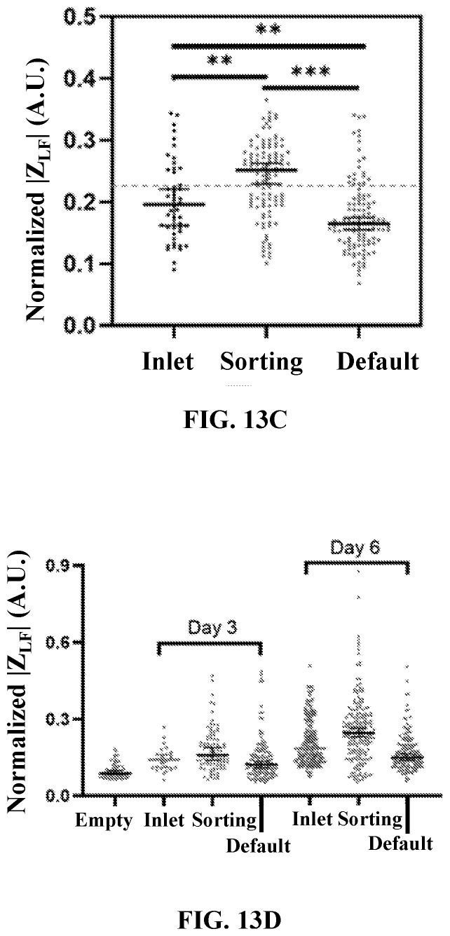

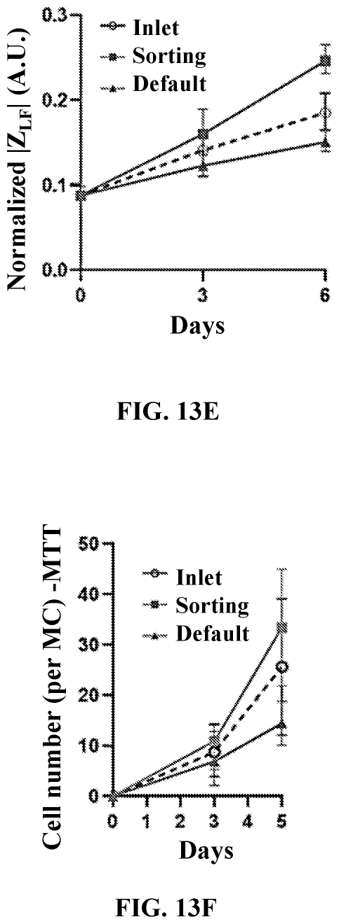

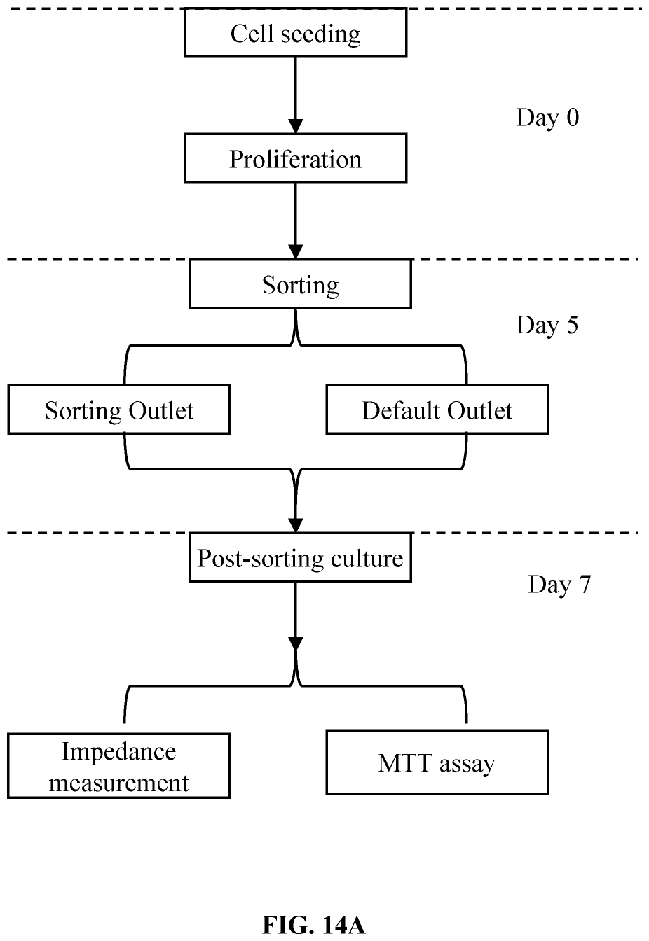

FIG. 13A schematically illustrates a workflow process for studying the capability of the present system and method to sort well-seeded microcarriers prior to cell expansion. Cultures of ADSCs and Cytodex-3 microcarriers were developed in a spinner flask with 50 mL working volume. The cell seeding was performed using an intermittent stirring strategy (40 revolutions per minute for 25 minutes, and keeping static for another 5 minutes), which was maintained for 4 hours before the samples were loaded into the microfluidic device 110 for sorting. The present system 100 was configured to sort out well-seeded microcarriers with higher cell densities. That is, the target particles of the sorting exercise were well-seeded microcarriers. The computing device 126 was programmed to actuate the actuator 142 if the low frequency impedance (|ZLF|) of a particle was found to be within a user-defined gating. In this case, the actuator 142 was actuated if the low frequency impedance of the particle was above a threshold. Samples collected from the sorting outlets 116 were observed and compared against samples collected from the default outlet (non-actuated channel). In particular, sorting performance was characterized by impedance measurement and MTT assay.

Cell density on microcarriers was found to be highly heterogeneous after the 4-hour cell seeding process as shown by the DAPI images of the microcarriers 4 hours after seeded with ADSCs (FIG. 13B). The normalized |ZLF| of the microcarriers before and after sorting at day 0 (4 hours post seeding) are shown in FIG. 13C (**p<0.005, ***p<0.0001).

The normalized low frequency impedance |ZLF| distribution of the inlet samples and sorted microcarriers from the sorting outlet 116 and the default outlet 114 on Day 3 and Day 6 after sorting are shown in FIG. 13D. FIG. 13E shows the normalized low frequency impedance ZLF| of the inlet samples and microcarriers from the sorting outlet 116 and the default outlet 114 over days (error bars indicating the 95% confidence interval). FIG. 13F shows the MTT assay results of the inlet samples and microcarriers from the sorting outlet 116 and the default outlet 114 over days indicating higher cell number for microcarriers from the sorting outlet 116 (error bars represent the range). Both impedance measurement and MTT assay demonstrated increasing trends in the biomass of all the samples, and microcarriers from the sorting outlets 116 consistently exhibited significantly higher biomass (FIGS. 13D to 13F). Noticeably, after 5-day culture, approaching three-fold increase in biomass was obtained in microcarriers collected from the sorting outlets 116 as compared to the default outlet 114 (FIG. 13F).

The results demonstrated the capability of the present system and method to sort out well-seeded microcarriers in a non-destructive, label-free, and automated manner. The target particles that were sorted out remained viable for further processing.

### Harvesting

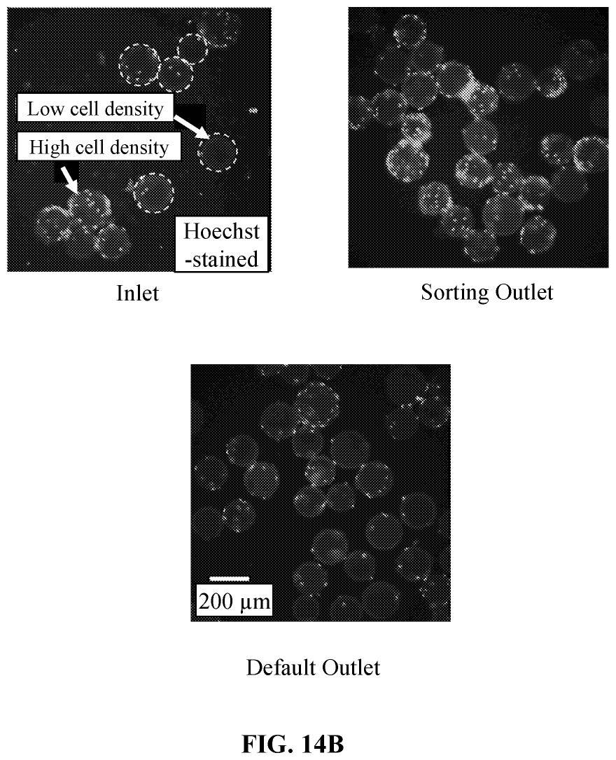

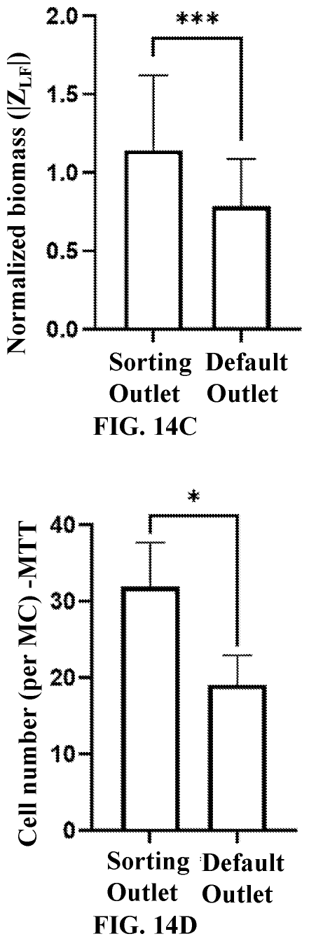

The present method was also applied to select high-biomass microcarriers for harvesting during the culture process (FIG. 14A to 14D). The sorting was implemented after a 5-day proliferation. Impedance measurement and MTT assay were used to assess the sorting performance after 2-day post-sorting culture. Fluorescent images of the Hoechst-stained sample demonstrated the heterogeneity of cell density on microcarriers after 5-day culture (FIG. 14A). After sorting, high-biomass microcarriers (target particles) were mostly collected from the sorting outlets 116 (FIG. 14B), while majority of low-biomass microcarriers entered the default outlet, which can be transferred back to incubator for continuous seed-train culture.

The microcarriers collected from sorting outlets 116 also had significantly higher |ZLF| (FIG. 14C) and MTT signals (FIG. 14D) than the unsorted microcarriers from default outlet, indicating that the present method can be used to select microcarriers with higher biomass for harvesting. Taken together, the present system and method can be used for sorting microcarriers based on the biomass on single microcarriers. This has huge potential for cell yield enhancement and drive improvements in cell seeding and harvesting.

Sorting Differentiated Cells from Undifferentiated Cells

In regenerative medicine, cell differentiation on microcarriers is heterogeneous due to the cell density or natural properties of cells. The capability of the present system to distinguish and select microcarriers with osteogenic differentiated cells from those with undifferentiated cells was experimentally verified.

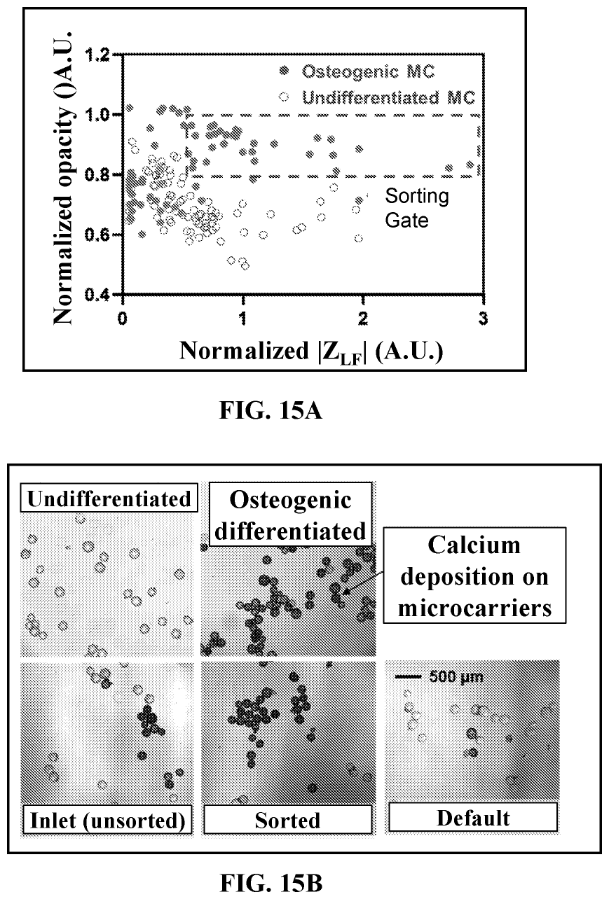

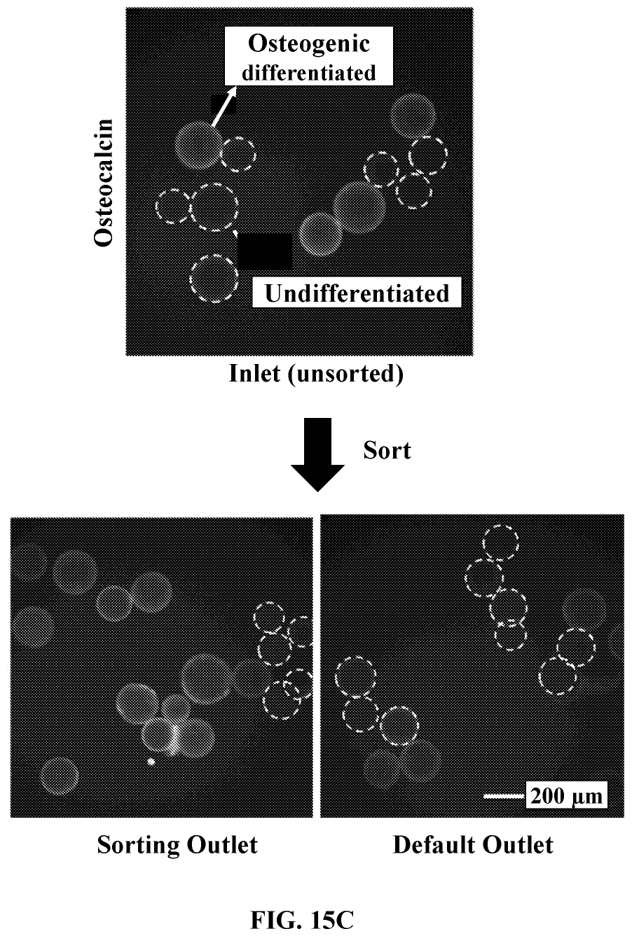

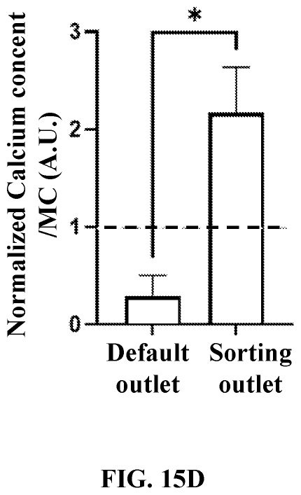

Impedance characterization showed that microcarriers with osteogenic differentiated cells have higher opacities than undifferentiated samples (FIG. 15A). The differentiated sample (opaque, due to calcium deposition) and the undifferentiated (white) sample were mixed together as an inlet sample and loaded into the microfluidic device 110 (FIG. 15B). After sorting based on a user-defined impedance gating, osteogenic differentiated microcarriers were successfully collected at sorting outlets 116 while undifferentiated microcarriers were collected from default outlet (FIG. 15B). The sorted samples were further confirmed by fluorescent images of osteocalcein staining (FIG. 15C). Calcium assay results also showed significantly higher calcium content in microcarriers from the sorting outlet in comparison to the default outlet (FIG. 15D). It is evident from the experimental results that the present system 100 has the unique capability to monitor osteogenic differentiation of cells on microcarriers and to select microcarriers with well-differentiated cells to ease the culture procedure and facilitate downstream processing. The experimental data also support the application of the present system and/or method to the sorting of cells of different types, e.g., osteogenic cells, fat cells, chondrocytes, based on the different impedance-based signal-related characteristics of the cells.

### Cell-Encapsulated Hydrogel Microparticles

Besides Cytodex microcarriers, cell-encapsulated hydrogel (e.g. alginate) microparticles are widely used in tissue engineering/reconstruction due to their high biocompatibility and potential as edible microcarriers. One skilled in the art will appreciate the difficulties in monitoring cellular properties (e.g., biomass and viability) in real-time, as extra processes would be needed to release the encapsulated cells. The present system 100 can be configured to implement biomass and/or viability-based sensing and sorting of alginate microparticles, and thereby address a long felt need in the field.

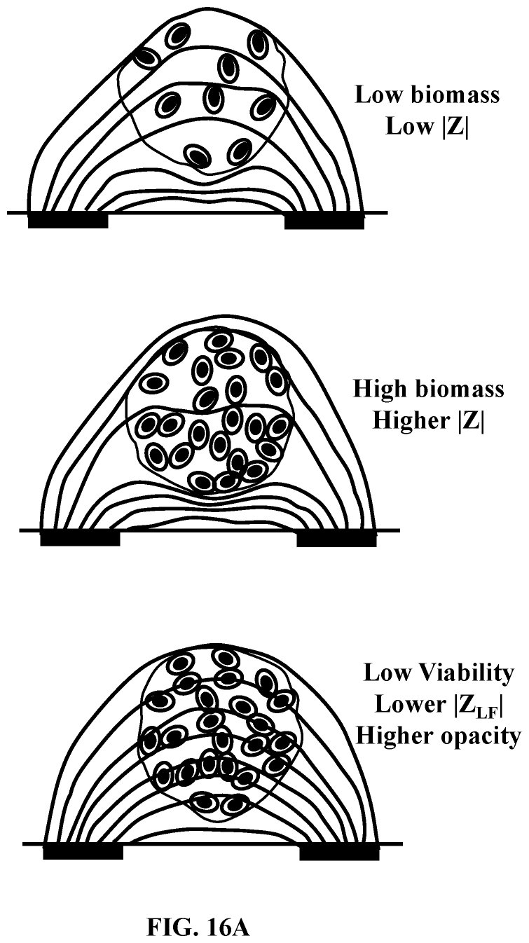

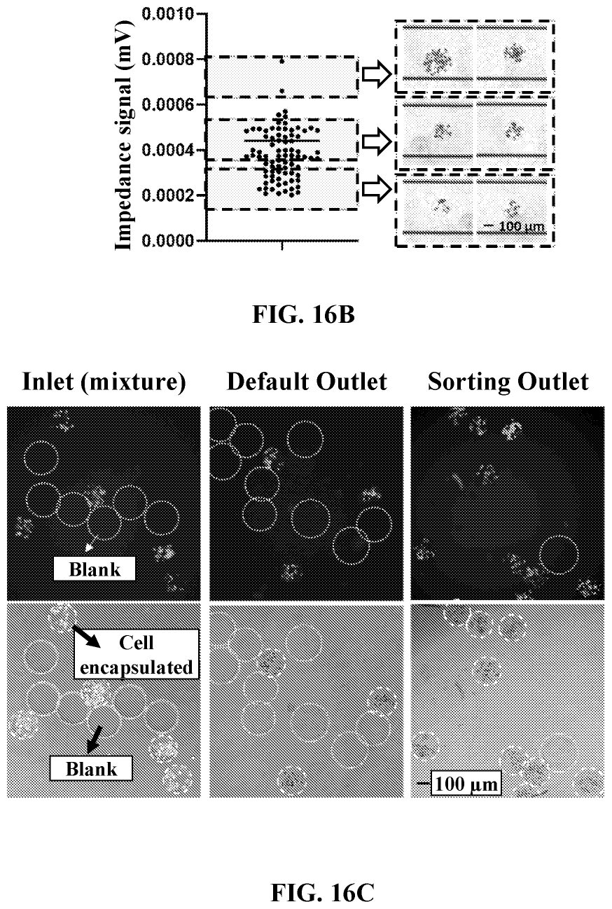

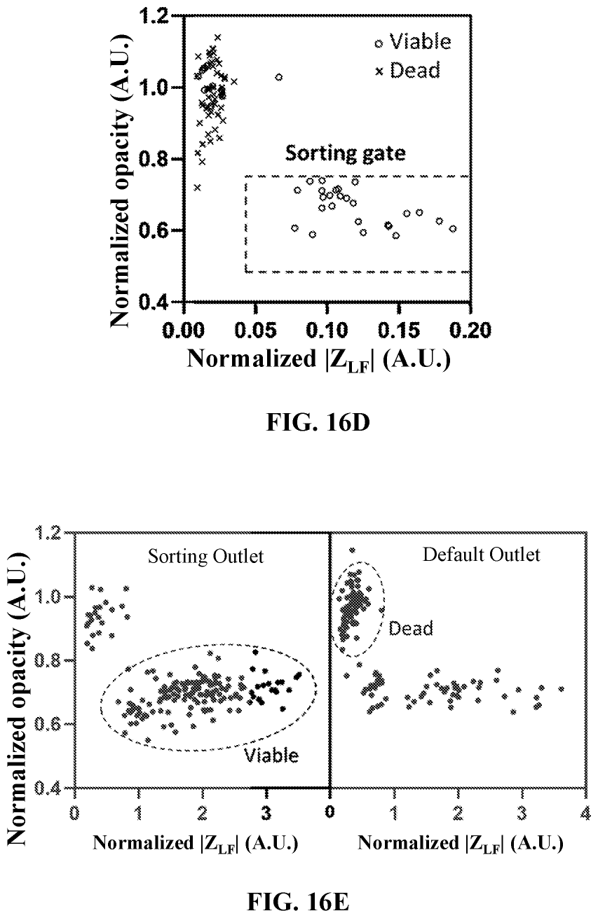

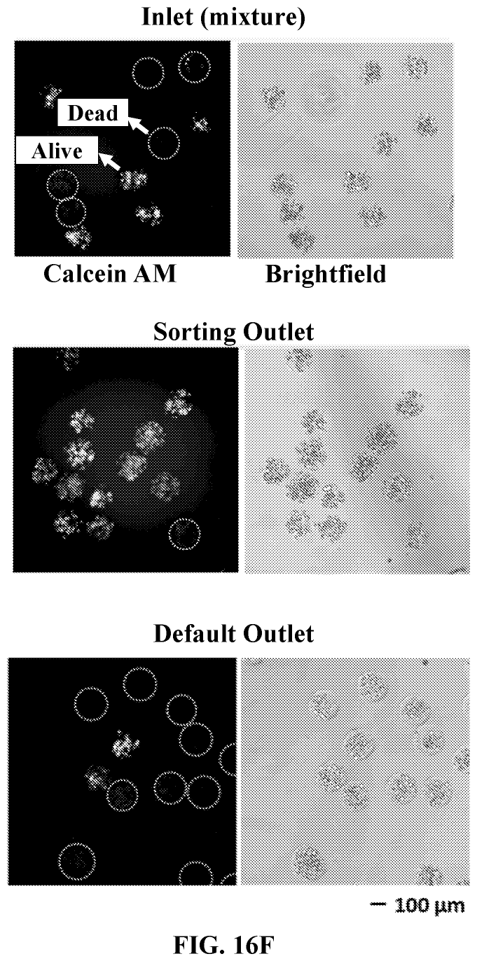

To demonstrate the sorting performance of the present system 100, an inlet sample was prepared by mixing cell-encapsulated microparticles (high impedance) and blank microparticles (low impedance). The computing device 126 was programmed to actuate the actuator 142 based on impedance magnitudes of the particles. The sorting criteria was programmed as a gating, in which the gating can be expressed as one threshold impedance value or as a combination of impedance-based thresholds. After sorting, the sample collected from the default outlet contained mostly blank microparticles, while more cell-encapsulated microparticles (the target particles in this case) were collected via the sorting outlets 116 (FIG. 16C), indicating good sorting performance based on the biomass of the particles.

The sorting by the present system 100 could be also based on differences in the impedance profiles caused by cell viability. This was demonstrated using microparticles encapsulating viable and dead cells (FIG. 16D). The sorting criteria was set to actuate the actuator 142 only if the low-frequency impedance magnitude and opacity are within a user-defined gating. In this example, the gating is a combination of a minimum impedance value and a maximum opacity (opacity is defined as a ratio of impedance values of different frequencies). That is, the impedance signals of the particle is compared against the impedance-base gating. If the impedance signals of a particle is above the minimum impedance value and if the opacity of the particle is below the maximum opacity, the particle will be determined to be a target particle. In this manner, microparticles with viable cells contributing to higher low-frequency impedance magnitude and lower opacity than microparticles with dead cells (damaged cell membrane in dead cells weakens dielectric dispersion effect and lowers the impedance magnitude at low frequency) were identified by the system 100, and once identified, the target particles could be deflected into the desired channel/outlet.

The user-defined gating which restricted both |ZLF| and opacity was set to select high-viability microparticles from the sample. Impedance profiles of samples from different outlets demonstrated that majority of high-viability microparticles (lower opacity) were successfully sorted into sorting outlets 116 while those with low viability (higher opacity) were mostly collected from the default outlet 114 (FIG. 16E). This was further validated by the fluorescent and brightfield images of the Calcein AM stained samples before and after sorting (FIG. 16F). The majority of microparticles from sorting outlets 116 showed positive fluorescent signals which indicated the presence of viable cells, while microparticles with dead cells were mostly observed in default outlet. Taken together, the present system 100 has been proven effective for multi-parametric sorting, e.g., in the biomass and viability-based sensing and sorting of cell-encapsulated alginate microparticles. These are useful capabilities in real-time cell monitoring and cell quality improvement in tissue engineering.

To further aid understanding and not to be limiting, Tables 2 and 3 below provide exemplary and non-limiting ranges of frequencies and gating (multi-parametric threshold settings) for the different applications described above.

TABLE 2
Applicable Ranges of Low Frequency and High
Frequency for Different Applications.

| | Range for | Range for |
|---|---|---|
| Application | low frequency | high frequency |
| Biomass | 60 kHz-500 kHz | N.A. (High frequency |
| | | is not used in biomass- |
| | | based sorting) |
| Osteogenic | 60 kHz-500 kHz | 1.5 MHz-5 MHz |
| differentiation | | |
| (microcarriers) | | |
| Viability | 60 kHz-500 kHz | 1.5 MHz-5 MHz |
| (alginate | | |
| microparticles) | | |

TABLE 3
Gating (Threshold Settings) for Different Applications.

| | Low | High | |
|---|---|---|---|
| Application | frequency | frequency | Gating |
| Biomass | 95 kHz | N.A. | Decided flexibly |
| | | | based on the sample |
| Osteogenic | 95 kHz | 2.1 MHz | Normalized \|Z_{LF}\| ∈ [0.5, 3] |
| differentiation | | | Normalized |
| (microcarriers) | | | opacity ∈ [0.8, 1] |
| Viability | 95 kHz | 2.1 MHz | Normalized \|Z_{LF}\| ∈ [0.05, 3] |
| (alginate | | | Normalized opacity ∈ |
| microparticles) | | | [0.4, 0.8] |

The various examples and experiments described above are clear evidence that the proposed system 100 (which can be described as a new type of microfluidic impedance spectroscopy system) and the proposed method 500 are useful for remote and label-free monitoring of microcarrier cultures, as well as real-time or on-demand sorting of microcarriers and other particles. The label-free impedance sensing capability obviates the need for fluorescence staining and optical microscopy processes to monitor cell growth. The real-time actuated sorting capability provides the possibility to sort microcarriers with specific cell properties which would improve and enable better control of the cell quality on microcarriers to facilitate downstream processing. The single-inlet device can be automated and readily integrated into a bioreactor so as to realise long-term cell culture without involving human manual operation. As evident from the foregoing, the method and system proposed herein can enable real-time and relatively effective automated sorting for practical industrial and laboratory applications, including biomanufacturing and bioprocesses such as biomass monitoring and sorting applications at single microcarrier resolution.

Advantageously, besides enabling automated direct sampling of microcarriers from a culture (e.g., bioreactors) and continuous and/or remote monitoring, the solution presented herein also addresses the challenges of monitoring mixtures of particles, especially in situations where just relying on averaged measurements can be misleading or in applications where the composition of the mixtures is indeterminate or changing. The same particles can be monitored over a long period of time, e.g., several days or even months. That is, the particles that are finally harvested can be themselves the subject of long-term monitoring through various stages of the culture (as opposed to destructive test/monitoring methods where the tested particles have to be discarded). Further, the experimental results demonstrate the viability of implementing the present method in scaled up versions for a broad range of biomass production or industrial applications, e.g., plant cell and tissue cultures for manufacturing food ingredients, etc.

Alternatively described, according to various embodiments, the present application discloses a method of sorting a plurality of particles, the method including: obtaining impedance signals of a particle as the particle is in motion toward an actuation region in a microfluidic device, the particle being one in the plurality of particles; determining if the particle is a target particle based on a comparison of one or more impedance-based gatings with the impedance signals of the particle; determining an actuation time for the particle, the actuation time being determined based on the impedance signals of the particle; and at the actuation time, deflecting the particle away from a default channel in the microfluidic device in response to determining that the particle is a target particle.

Preferably, the method includes aligning the plurality of particles into a stream of spaced apart ones of the plurality of particles before the obtaining of the impedance signals. Preferably, the plurality of particles are aligned by hydrodynamic focusing. Preferably, the method includes determining a particle speed of the particle based on a transit time taken by the particle to travel from a first detection region to a second detection region, wherein the impedance signals of the particle are obtained at each of the first detection region and the second detection region, and wherein the second detection region is spaced apart from and downstream of the first detection region. Preferably, the method includes determining a particle speed of the particle based on the impedance signals of the particle. Preferably, the particle speed is determined for the particle on a particle-by-particle basis. Preferably, the particle speed for the particle is determined with disregard for any one or more of the following: a speed of any other of the plurality of particles and a flow rate of a medium.

Preferably, the actuation time is timed to synchronize an actuation of an actuator with the particle arriving at the actuation region. Preferably, the actuation time in respect of the particle includes a waiting time to provide time for completing calculations based on the impedance signals of the particle. Preferably, the method includes, in response to determining that the particle is not the target particle, allowing the particle to continue in the default channel by not deflecting the particle at the actuation time. Preferably, the plurality of particles includes particles of different sizes, and wherein the target particle is a particle characterized by a size within a selected range of the different sizes.

Preferably, the plurality of particles includes cells of different cell types, and wherein the target particle is one or more selected from the different cell types. Preferably, the plurality of particles includes cells of different degrees of cell differentiation, and wherein the target particle is a cell characterized by a degree of cell differentiation within a selected range of the different degrees of cell differentiation. Preferably, the plurality of particles includes microcarriers of various cell densities, and wherein the target particle is a microcarrier with a cell density higher than a threshold cell density corresponding to the one or more impedance-based gatings. Preferably, the plurality of particles includes a mixture of single microcarriers and microcarrier aggregates, and wherein the target particle includes one of the single microcarriers and the microcarrier aggregates. Preferably, the plurality of particles includes cell-laden microcarriers with various amount of biomass, and wherein the target particle includes cell-laden microcarrier with cell proliferation. Preferably, the one or more impedance-based gatings comprise an impedance magnitude and an opacity, the opacity being defined as a ratio of impedances at different frequencies. Preferably, the plurality of particles includes a mixture of empty microcarriers and cell-laden microcarriers, and wherein the target particle includes the cell-laden microcarriers. Preferably, the plurality of particles includes seeded microcarriers before cell proliferation, and wherein the target particle includes the seeded microcarriers with a cell density above a cell density threshold. Preferably, the plurality of particles includes a mixture of differentiated cells and undifferentiated cells, and wherein the one or more impedance-based gatings comprise an opacity, the opacity being defined as a ratio of impedances at different frequencies. Preferably, the plurality of particles includes a mixture of blank microparticles and cell-encapsulated hydrogel microparticles, and wherein the target particle includes the cell-encapsulated hydrogel microparticles. Preferably, the plurality of particles includes a mixture of dead cells and viable cells. Preferably, each of the one or more gatings includes any one or any combination of the following: an impedance-based value, an impedance-based threshold, and an impedance-based range.

Various embodiments of the present disclosure may alternatively be described in terms of a system configured to implement the method of sorting a plurality of particles. The system includes a microfluidic channel extending through a first detection region and a second detection region to an actuation region, the first detection region and the second detection region having electrodes to obtain impedance signals of a particle as the particle is in motion toward the actuation region, the particle being one in the plurality of particles, the microfluidic channel dividing into a default channel and at least one sorting channel; an actuator provided at the actuation region; and a computing device configured to perform the following: determine if the particle is a target particle based on a comparison of one or more impedance-based gatings with the impedance signals of the particle; determine an actuation time for the particle, the actuation time being determined based on the impedance signals of the particle; and in response to determining that the particle is a target particle, send instructions to actuate the actuator at the actuation time to deflect the particle away from the default channel into the sorting channel.

Preferably, the system includes a focusing region upstream of the first detection region, wherein the focusing region is configured with a non-linear geometry such that the plurality of particles are aligned into a stream of successively spaced apart ones of the plurality of particles. Preferably, the microfluidic channel between the second detection region and the actuation region is of a path length such that the particle arrives at the actuation region in synchrony with the actuation time. Preferably, the computing device is configured to determine a particle speed based on a transit time taken by the particle to travel from a first detection region to a second detection region, and wherein the particle speed is determined for the particle on a particle-by-particle basis.

All examples described herein, whether of apparatus, methods, materials, or products, are presented for the purpose of illustration and to aid understanding, and are not intended to be limiting or exhaustive. Modifications may be made by one of ordinary skill in the art without departing from the scope of the invention as claimed.

1. A method of sorting a plurality of particles, the method comprising:
obtaining impedance signals of a particle as the particle is in motion toward an actuation region in a microfluidic device, the particle being one in the plurality of particles;
determining if the particle is a target particle based on a comparison of one or more impedance-based gatings with the impedance signals of the particle;
determining an actuation time for the particle, the actuation time being determined based on the impedance signals of the particle; and
at the actuation time, deflecting the particle away from a default channel in the microfluidic device in response to determining that the particle is a target particle.

2. The method according to claim 1, comprising:
aligning the plurality of particles into a stream of spaced apart ones of the plurality of particles before the obtaining of the impedance signals, wherein the plurality of particles are aligned by hydrodynamic focusing.

3. (canceled)

4. The method according to claim 1, comprising:
determining a particle speed of the particle based on a transit time taken by the particle to travel from a first detection region to a second detection region, wherein the impedance signals of the particle are obtained at each of the first detection region and the second detection region, and wherein the second detection region is spaced apart from and downstream of the first detection region.

5. The method according to claim 1, comprising:
determining a particle speed of the particle based on the impedance signals of the particle,
wherein the particle speed is determined for the particle on a particle-by-particle basis,
wherein the particle speed for the particle is determined with disregard for any one or more of the following: a speed of any other of the plurality of particles and a flow rate of a medium in the microfluidic device.

6. (canceled)

7. (canceled)

8. The method according to claim 1, wherein the actuation time is timed to synchronize an actuation of an actuator with the particle arriving at the actuation region, wherein the actuation time in respect of the particle comprises a waiting time to provide time for completing calculations based on the impedance signals of the particle.

9. (canceled)

10. The method according to claim 1, comprising:
in response to determining that the particle is not the target particle, allowing the particle to continue in the default channel by not deflecting the particle at the actuation time.

11. The method according to claim 1, wherein the plurality of particles comprises particles of different sizes, and wherein the target particle is a particle characterized by a size within a selected range of the different sizes.

12. The method according to claim 1, wherein the plurality of particles comprises cells of different cell types, and wherein the target particle is one or more selected from the different cell types.

13. The method according to claim 1, wherein the plurality of particles comprises cells of different degrees of cell differentiation, and wherein the target particle is a cell characterized by a degree of cell differentiation within a selected range of the different degrees of cell differentiation.

14. The method according to claim 1, wherein the plurality of particles comprises microcarriers of various cell densities, and wherein the target particle is a microcarrier with a cell density higher than a threshold cell density corresponding to the one or more impedance-based gatings.

15. The method according to claim 1, wherein the plurality of particles comprises a mixture of single microcarriers and microcarrier aggregates, and wherein the target particle comprises one of the single microcarriers and the microcarrier aggregates.

16. The method according to claim 1, wherein the plurality of particles comprises cell-laden microcarriers with various amount of biomass, and wherein the target particle comprises cell-laden microcarrier with cell proliferation, wherein the one or more impedance-based gatings comprise an impedance magnitude and an opacity, the opacity being defined as a ratio of impedances at different frequencies.

17. (canceled)

18. The method according to claim 1, wherein the plurality of particles comprises a mixture of empty microcarriers and cell-laden microcarriers, and wherein the target particle comprises the cell-laden microcarriers.

19. The method according to claim 1, wherein the plurality of particles comprises seeded microcarriers before cell proliferation, and wherein the target particle comprises the seeded microcarriers with a cell density above a cell density threshold.

20. The method according to claim 1, wherein the plurality of particles comprises a mixture of differentiated cells and undifferentiated cells, and wherein the one or more impedance-based gatings comprise an opacity, the opacity being defined as a ratio of impedances at different frequencies.

21. The method according to claim 1, wherein the plurality of particles comprises a mixture of blank microparticles and cell-encapsulated hydrogel microparticles, and wherein the target particle comprises the cell-encapsulated hydrogel microparticles.

22. The method according to claim 1, wherein the plurality of particles comprises a mixture of dead cells and viable cells.

23. The method according to claim 1, wherein each of the one or more gatings comprises any one or any combination of the following: an impedance-based value, an impedance-based threshold, and an impedance-based range.

24. A system configured to implement the method of sorting a plurality of particles according to claim 1, the system comprising:
a microfluidic channel extending through a first detection region and a second detection region to an actuation region, the first detection region and the second detection region having electrodes to obtain impedance signals of a particle as the particle is in motion toward the actuation region, the particle being one in the plurality of particles, the microfluidic channel dividing into a default channel and at least one sorting channel;
an actuator provided at the actuation region; and
a computing device configured to perform the following:
determine if the particle is a target particle based on a comparison of one or more impedance-based gatings with the impedance signals of the particle;
determine an actuation time for the particle, the actuation time being determined based on the impedance signals of the particle; and
in response to determining that the particle is a target particle, send instructions to actuate the actuator at the actuation time to deflect the particle away from the default channel into the sorting channel.

25. The system according to claim 24, further comprising a focusing region upstream of the first detection region, wherein the focusing region is configured with a non-linear geometry such that the plurality of particles are aligned into a stream of successively spaced apart ones of the plurality of particles, wherein the microfluidic channel between the second detection region and the actuation region is of a path length such that the particle arrives at the actuation region in synchrony with the actuation time, wherein the computing device is configured to determine a particle speed based on a transit time taken by the particle to travel from a first detection region to a second detection region, and wherein the particle speed is determined for the particle on a particle-by-particle basis.

26. (canceled)

27. (canceled)
